(19) United States
(12) Patent Application Publication
(10) Pub. No.: US 2009/0094142 A1
(43) Pub. Date: Apr. 9, 2009

(54) Method and Server for Managing Subscriber Charges

(75) Inventors: Rainer Falk, Erding (DE); Christian Gunther, Neubiberg (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/226,680

(22) PCT Filed: Mar. 12, 2007
(86) PCT No.: PCT/EP2007/052300

§ 371 Date: Oct. 24, 2008

(30) Foreign Application Priority Data
Apr. 26, 2006 (DE) 10 2006 019 465.9

(51) Int. Cl. G06Q 20/00

(52) U.S. Cl. 705/30

(57) ABSTRACT

A fee management server manages subscriber fees by managing an actual fee credit and an available fee credit for very subscriber. Upon receipt of a fee accounting message by a server for accounting fees for a communication service desired by the subscriber, the fee management server transmits a recall message for recalling communication units already allocated for another communication service if the available fee credit of the subscriber is lower and if an actual fee credit is higher than an amount specified in the fee accounting message for the desired communication service.

### CROSS REFERENCE TO RELATED APPLICATIONS

This application is based on and hereby claims priority to German Application No. 10 2006 019 465.9 filed on Apr. 26, 2006, the contents of which are hereby incorporated by reference.

### BACKGROUND

Described below is a method and a server for managing subscriber charges, in particular in the case of subscribers having prepaid charge credits.

Prepaid systems, that is to say systems based on payment in advance, give subscribers or, as the case may be, customers the option of paying upfront for communication services or application services such as MMS (Multimedia Messaging Service), SMS (Short Message Service) and SIP (Session Initiation Protocol) or for downloading or for making telephone calls in order to receive a charge credit from a provider, more specifically a communication service provider. When a subscriber avails himself/herself of a communication service or application service, the charge credit is reduced in accordance with the communication units KE used. Traditionally the communication units KE are time units which specify the duration of a communication connection, or data volume units which specify an amount of transferable data. For example, one charge unit is deducted from the subscriber's charge credit for each minute of a telephone call or for every 1 MB of transferred data. With prepaid systems, charge accounting takes place while the communication is being conducted so that the subscriber's available charge credit is not overdrawn.

In mobile radio networks, a subscriber can communicate simultaneously via a plurality of communication connections or links and in particular via different access networks, in particular via a 3GPP (Third Generation Partnership Project), a WLAN (Wireless Local Area Network) and a WiMax (Worldwide Interoperability for Microwave Access) access network. In a known communication system, a charge management server or AAA (Authentication Authorization and Accounting) server allocates the access network server a quota of communication units KE or a time and/or volume quota for that purpose. When the allocated quota of communication units has been used up as a result of the service, specifically a desired communication service, having been used, a new quota of communication units is allocated by the known charge management server provided the subscriber has a sufficient fixed charge credit.

If a subscriber uses a plurality of links in parallel or if the subscriber communicates simultaneously over a plurality of separate access networks of different network operators, on the one hand the subscriber's available charge credit must not be overdrawn, but at the same time it is important that each link be maintained if a charge credit is still available. When a subscriber uses different communication services simultaneously, a specific quota of communication units is made available to him/her in advance by the known charge management server for each of the different communication services. The situation therefore often arises that a communication service can no longer be maintained or a newly requested communication service cannot be provided because the subscriber's available remaining charge credit is not sufficient to allow a continuation of the communication service or for the newly requested communication service even though remaining quotas of allocated communication units for other communication services are still present which have not yet been used up by the subscriber.

### SUMMARY

An aspect is to provide a method and a charge management server for managing subscriber charges which allocate communication units to the access network servers in such a way that the subscriber's charge credit is sufficient for the longest time possible for maintaining existing communication services and for setting up desired communication services.

The method described below allocates communication units to access network servers by a charge management server which manages a charge credit for each subscriber, wherein the charge management server, upon receiving a charge accounting message for accounting charges for a communication service desired by a subscriber, sends a recall message to an access network server in order to recall already allocated communication units if an available charge credit VG of the subscriber is less than and an actual charge credit TG of the subscriber is higher than the charge amount specified in the charge accounting message for the desired communication service.

The method described below has the advantage that it avoids the overdrawing of a prepaid charge credit and at the same time enables a plurality of communication services to be used in parallel and in the process the prepaid charge credit to be used up completely.

A further advantage of the method described below is that the signaling overhead for charge management is minimized, in particular when a subscriber's remaining charge credit is small.

A further advantage of the method described below is that the number of subscriber interactions with the charge management server for topping up the prepaid charge credit is reduced.

With the method described below, the charge management server recalls unused communication units KE as necessary in order to be able to reassign them for a different communication service. To that end the charge management server queries the already actually expended part of the communication units KE used by a communication service and allocates the portion of communication units not yet used to a different or to a new communication service as necessary. This is advantageous in particular when a subscriber's initial charge credit is about to run out and a new quota of communication units has to allocated for a link or for a different communication service or when it is necessary to levy a charge for an individual event, the downloading of a ringtone for example. The charge management server then weighs up to what extent the already granted quotas of communication units have already been used up, the server reallocating the as yet unused or unexpended communication units for example to a different access network or using them for the charge-related accounting of an individual event.

In an embodiment of the method described below the charge management server, after receiving a service registration message for registering a subscriber for a desired communication service, makes a specific quota of usable communication units available to the subscriber in an allocation message and reduces the subscriber's available charge credit VG by those charges that are incurred for the communication units KE that were made available.

In an embodiment of the method described below the charge management server, after receiving a charge accounting message for accounting charges for a communication service provided for a subscriber, reduces the subscriber's actual charge credit TG by those charges that are incurred for the communication units KE used up during the provisioning of the communication service.

In an embodiment of the method described below the charge management server, after receiving the charge accounting message for accounting charges for a communication service provided for a subscriber, increases the subscriber's available charge credit VG by those charges that are incurred for a difference between the communication units made available for the communication service and the communication units used during the provisioning of the communication service.

In an embodiment of the method described below the charge management server, after receiving a charge accounting message for accounting charges for a communication service provided to a subscriber, makes a new quota of usable communication units available to the subscriber in an allocation message and reduces the subscriber's available charge credit VG by those charges that are incurred for the communication units that have been made available.

In an embodiment of the method described below the charge management server sends an allocation message for allocating a specific quota of usable communication units to the access network server from which the charge management server has received a service registration message.

In an embodiment of the method described below the charge management server receives the service registration messages and the charge accounting messages in each case from one or more access network servers of different access networks.

In an embodiment of the method described below the charge management server sends the allocation messages and the recall messages in each case to one or more access network servers of different access networks.

The access networks are in each case preferably formed by a mobile radio network.

The mobile radio networks are preferably a 3GPP network, a WLAN network or a WiMax network.

In an embodiment of the method described below the communication units KE are formed by data volume units which specify an amount of transferable data.

In an embodiment of the method described below the communication units KE are formed by time units which specify a duration of a communication connection.

In an embodiment of the method described below a subscriber's actual charge credit TG and available charge credit VG are initialized to a starting value after payment of a charge amount by the subscriber.

Also described below is a charge management server for managing subscriber charges, wherein the charge management server, upon receiving a charge accounting message from an access network server for accounting charges for a communication service desired by a subscriber, sends a recall message to recall communication units KE already allocated for a different communication service if the subscriber's available charge credit VG is less than and the subscriber's actual charge credit TG is higher than a charge amount specified for the desired communication service in the charge accounting message.

### BRIEF DESCRIPTION OF THE DRAWINGS

These and other aspects and advantages will become more apparent and more readily appreciated from the following description of the preferred embodiments, taken in conjunction with the accompanying drawings of which:

FIG. 1 is a block diagram of a communication system including a charge management server, the communication system having a plurality of access networks;

FIG. 2 is a flowchart of a possible embodiment of a method for allocating communication units;

FIG. 3 is a data flow diagram serving to explain the mode of operation of the method for allocating communication units with the aid of an example; and

FIG. 4 is a table serving to represent a charge credit list managed by a charge management server for different subscribers.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

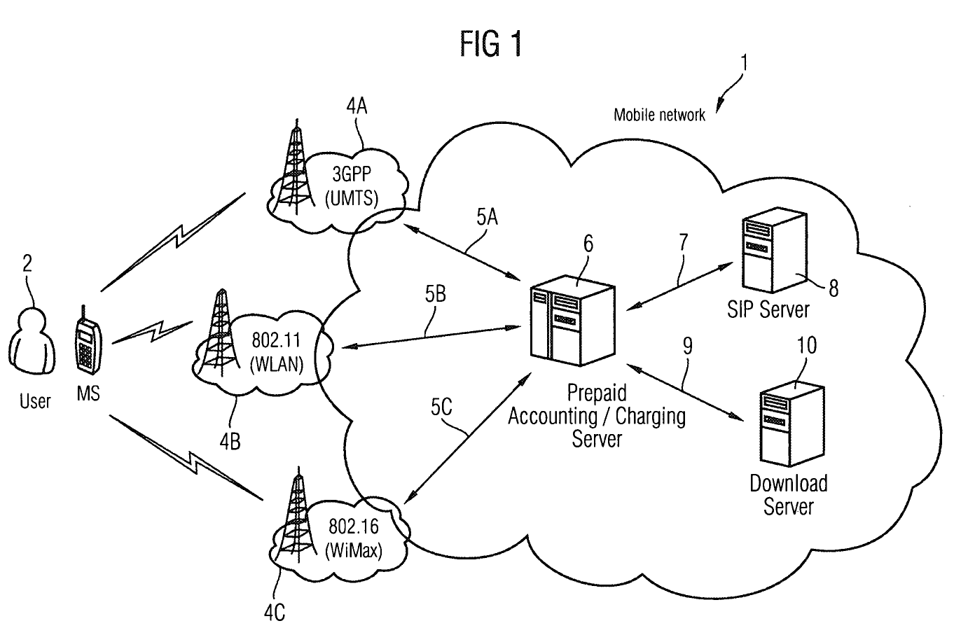

FIG. 1 shows a communication system 1 in which a subscriber 2 maintains different bidirectional communication connections to access networks in parallel via a mobile terminal device 3. In the example shown, the communication system 1 has three access networks 4A, 4B, 4C, each of which has an access network server. In the example shown, the first access network 4A is a 3GPP network, for example a UMTS or GSM access network. The second access network 4B is a WLAN (Wireless Local Area Network) and the third access network 4C is a WiMax (Worldwide interoperability for Microwave Access) network. The access network servers of the access networks 4A, 4B, 4C are connected to a charge management server 6 via a data connection 5A, 5B, 5C respectively. The charge management server 6 manages the charge credits of a plurality of subscribers 2. The charge management server 6 is preferably connected to an SIP (Session Initiation Protocol) server 8 via a data line 7 and to a download server 10 via a data line 9. The SIP server 8 is used for instant messaging or Voice over IP. The download server 10 serves for data downloads performed by the subscriber. The SIP server 8 and the download server 10 exchange charge accounting data with the charge management server 6.

The charge credits of a plurality of subscribers are managed in the charge management server 6. The charge management server 6 allocates communication units KE to the different access network servers of the access networks 4A, 4B, 4C in accordance with the charge credit of the respective subscriber.

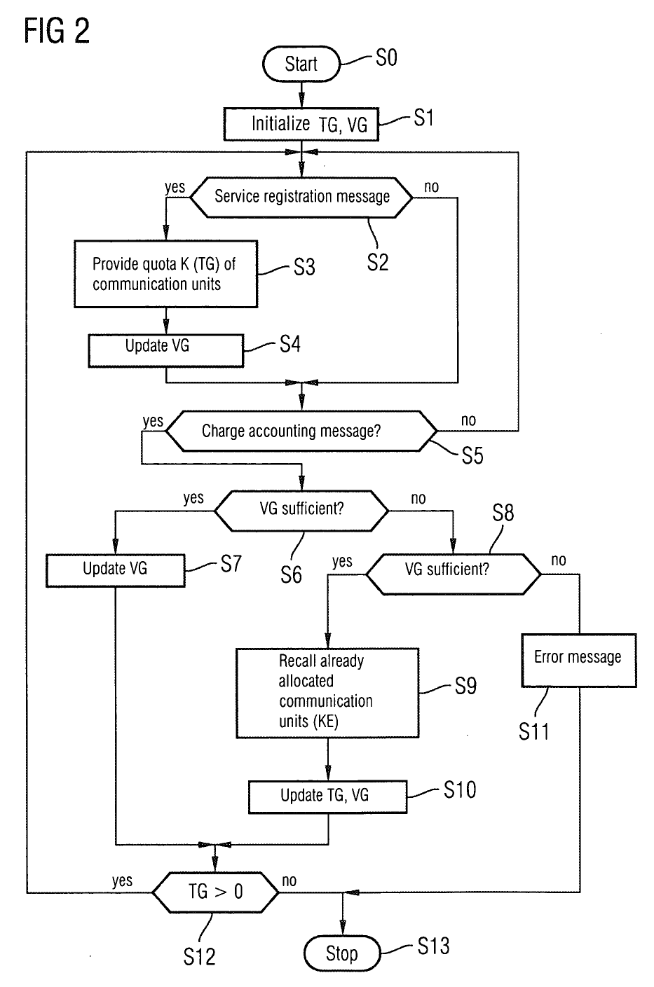

FIG. 2 shows a flowchart of a possible embodiment of the method for allocating communication units KE for different access network servers by the charge management server 6 in accordance with a subscriber's charge credit.

Following a start step S0 the subscriber's charge credit is first initialized in step S1.

In the method described herein a subscriber's charge credit may be a tuple having two values, namely the subscriber's actual charge credit TG and the subscriber's currently available charge credit VG. The available credit VG is in this context a charge credit for communication units KE that have not yet been allocated.

A subscriber's available credit VG results from the difference between the actual charge credit TG and the total charges for all communication units KE reserved for communication services:

$$V G = T G - \frac{G}{K E} {\sum }_{k - 1}^{N} {k}_{i} \cdot K E , \qquad ( 1 )$$

where G represents the charge per communication unit KE,
kᵢ the quota of communication units KE for the respective communication service, and N the number of communication services for which communication units KE are allocated.

As can be seen from equation (1), the available charge credit VG is always less than or equal to the subscriber's actual charge credit TG. A subscriber receives a charge credit by paying in a charge amount to the service provider, for example 25 [symbol] for 25 charge units. In practice an access code on a prepaid card for example is revealed by scratching e.g. with a coin and the corresponding amount is credited to the subscriber by the provider following receipt of the access code. The subscriber's actual charge credit TG and available charge credit VG are initially initialized to the same value in a step S1.

As soon as the charge management server 6 receives a service registration message from the subscriber for registering the subscriber for a desired communication service in a step S2, the subscriber is provided with a specific quota k of usable communication units KE for this communication service in advance in a step S3. The communication units KE are time units which specify a duration of a communication connection, or data volume units which specify an amount of transferable data. For example, one communication unit KE amounts to one minute of a voice connection or the communication unit KE may be, for example, one megabyte of transferable or downloadable data. In one possible embodiment the amount of communication units KE made available in the quota K is deducted from the subscriber's actual charge credit TG.

After the charge management server has provided a quota of communication units KE for the requested communication service in step S3, the subscriber's available charge credit VG is updated in step S4. After the subscriber has received the quota of usable communication units KE in an allocation message, the subscriber's available charge credit VG is reduced by those charges that have been incurred for the communication units KE that were made available:

$$V G \text{:} = V G - \frac{G}{K E} \cdot K \cdot K E . \qquad ( 2 )$$

Next, in step S5, the charge management server 6 checks whether it has received a charge accounting message from an access network server of the access network 4. The charge accounting message contains a charge amount for accounting charges for the communication service provided.

In step S6, the charge management server 6 first checks whether the subscriber's available credit VG is sufficient for the required charge amount.

If this is the case, the subscriber's actual charge credit TG and available charge credit VG are updated in step S7. For that purpose the subscriber's actual charge credit is reduced by those charges that have been incurred for the communication units KE used up during the provisioning of the communication service.

$$T G \text{:} = T G - \frac{G}{K E} \cdot vK E , \qquad ( 3 )$$

where vKE represents the communication units KE used up during the provisioning of the communication service.

Furthermore, following receipt of the charge accounting message the subscriber's available charge credit VG is increased by those charges arising for a difference between the communication units KE made available in advance for the communication service and the communication units KE actually used during the provisioning of the communication service:

$$V G \text{:} = V G + \frac{G}{K E} ( K \cdot K E - v \cdot K E ) .$$

If it is established in step S6 that the subscriber's currently available charge credit VG is not sufficient to cover the amount required in the charge accounting message, a check is carried out in the charge management server 6 in step S8 to determine whether at least the subscriber's actual charge credit TG is higher than the charge amount specified for the desired communication service in the charge accounting message. If this is the case, in step S9 the charge management server 6 sends a recall message to at least one access network server of an access network 4 in order to recall communication units KE that have already been made available.

Next, in step S10, the subscriber's actual charge credit TG and available charge credit VG are updated in accordance with the number of communication units KE that can still be credited.

If it is established in step S8 that the subscriber's actual charge credit TG is also not sufficient to cover the amount required in the charge accounting message, error handling is performed in step S11.

In step S12, the charge management server 6 checks whether the actual charge credit TG is greater than zero and therefore communication services can still be provided. If the subscriber's actual charge credit TG is greater than zero, the process returns to step S2, i.e. the charge management server 6 waits for the next service registration message from the subscriber. If, on the other hand, the subscriber's charge credit TG is completely used up, the process terminates in step S13.

The sequence flow of the method shown in FIG. 2 is merely a possible embodiment of the method and can be modified in many different ways. For example, after receiving the charge accounting message from an access network server for the purpose of accounting charges for a communication service performed by a subscriber, the charge management server 6 can automatically make a new quota of usable communication units KE available to the subscriber in an allocation message and reduce the available charge credit VG accordingly.

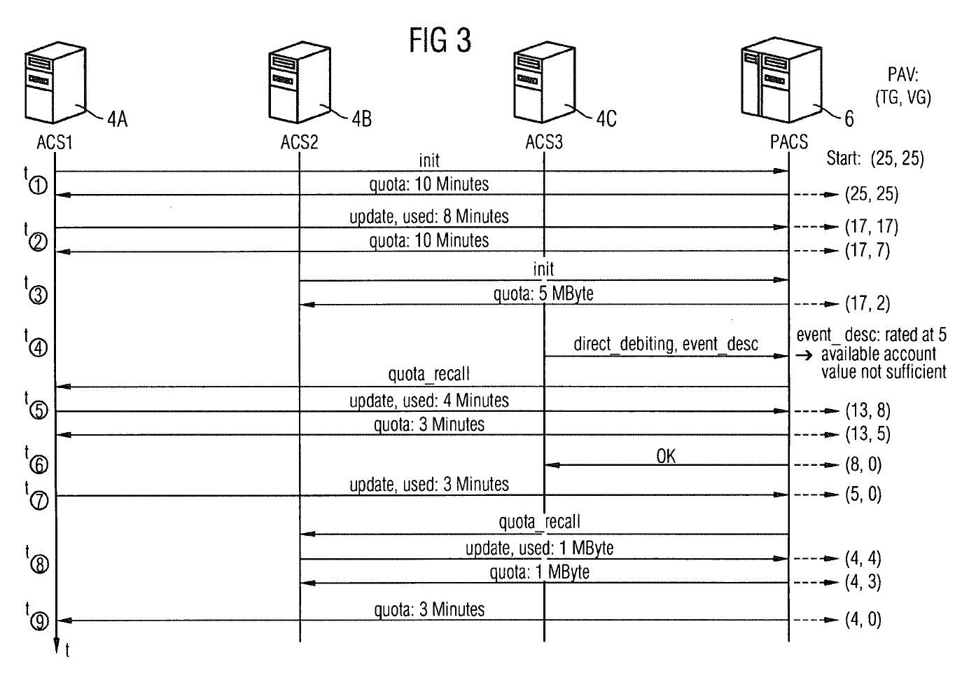

The method is clarified below with reference to the example illustrated in FIG. 3. The diagram depicted in FIG. 3 shows a charge management server 6 or PACV (Prepaid Accounting Charging Server) which receives messages from three different access network servers or ACS (Accounting Charging Source) servers that are provided for different networks for example. In the example chosen in FIG. 3, a subscriber communicates simultaneously via three different links in parallel, for example a UMTS link, a WLAN link and a WiMax link. In the example the subscriber's charge credit is first initialized to a starting value of (25,25) by payment of a corresponding amount, i.e. initially the subscriber's actual credit TG and available credit VG each amount to 25.

At time t₁ the charge management server 6 receives a service registration message (INIT) from the access network server ACS1 for the purpose of registering the subscriber for a desired communication service, a telephone call for example. The charge management server 6 makes a specific quota K of usable communication units KE available to the access network server of the access network ACS1 in an allocation message. In the example, the access network server ACS1 receives ten time units as communication units KE which specify a duration of ten minutes for a telephone communication connection, i.e. the subscriber is initially able to telephone for ten minutes via the access network 4A. The subscriber's available charge credit VG is reduced by those charges that are incurred for the communication units KE made available. In the example chosen, a charge is incurred for each minute of the call. Accordingly the available charge credit is reduced by 10 units from 25 to 15.

At time t₂ the access network server ACS1 sends the charge management server 6 a charge accounting message which specifies the resources or communication units KE actually used. In the example chosen, the subscriber has telephoned for eight minutes of the ten minutes made available. The subscriber's actual charge credit TG is reduced by those charges that have accrued for the communication units during the provisioning of the communication service, i.e. by eight units, so the actual charge credit TG is reduced from 25 to 17. The difference between the communication units KE made available for the communication service and the communication units KE actually used during the provisioning of the communication service is credited to the subscriber's available charge credit VG, i.e. the subscriber's available credit VG increases from 15 to 17. After receiving the charge accounting message at time t₂, the charge management server 6 automatically makes a new quota of usable communication units available to the subscriber in an allocation message. In the example shown, the subscriber is allowed the possibility of conducting another ten-minute telephone call. The subscriber's available charge credit VG is reduced accordingly by ten units to seven.

At time t₃ the user signs on in a second access network 4B via the access network server ACS2. The ACS server 2 sends a service registration message to the charge management server 6. In the example shown, the charge management server 6 grants a quota or volume of 5 MB for this communication service, i.e. the communication units KE is in this case of data volume units which specify an amount of transferable data. In the example chosen, one charge unit corresponds to 1 MB of transferable data, so the subscriber's available credit VG is reduced from 7 to 2.

At time t₄ the subscriber now wants to download a content data element, for example a ringtone or a game, from the download server 10, the data content costing five charge units. The server ACS3 belonging to the download server sends a corresponding charge accounting message to the charge management server 6. Five charge units are incurred for the desired download. In the example chosen the subscriber's available credit VG is no longer sufficient to cover this download. With a known charge management server this would lead to an error message and the subscriber would not be able to download the desired data content.

With the method or the charge management server 6, however, in the specified example a recall message is sent by the charge management server 6 at time t₅ to the server ACS1 (quota_recall). The charge management server sends a recall message whenever a subscriber's available charge credit VG is less than a charge amount specified for a desired communication service in the charge accounting message and at the same time the subscriber's actual charge credit TG is higher than the specified charge amount. Using the recall message (quota_recall) the charge management server 6 recalls either all or part of an already granted quota or an allocation of communication units KE already made available from the respective server. After the server ACS1 has received the recall message from the charge management server 6, it bills the resources that it has already used by sending a charge accounting message back to the charge management server 6. In the example chosen, the server ACS1 has used four minutes of the ten minutes made available at time t₂. The subscriber's actual charge credit is reduced accordingly by four units from 17 to 13. The remaining six minutes are credited to the subscriber's available credit VG, with the result that the subscriber's available credit VG is increased from 2 to 8. A new volume of three minutes is made available as a new quota to the server ACS1, so the available charge credit VG is reduced by three units from 8 to 5. The quota made available in each case preferably depends on the amount of the actual charge credit TG that is still available. The greater the still available charge credit TG, the greater also can be the quota K of communication units KE made available in each case.

After the recalling of the communication units KE at time t₅, the subscriber's available credit VG is increased to five units and consequently is sufficient for the desired data download. At time t₆ the ACS server 3 therefore receives an Okay message indicating to the server 3 that the download can now be performed. Upon completion of the download, in which for example 5 MB to the value of five charge units is downloaded, the subscriber's actual charge credit TG and available charge credit VG are each reduced by five.

In the example chosen, at time t₇ the ACS server 1 sends a charge accounting message to the charge management server 6 for the used communication units KE. In the example chosen, a call lasting three minutes and having a value of three charge units is billed. The subscriber's actual charge credit TG is reduced accordingly by three units. The available credit VG remains at the value zero since the resources actually used correspond to the communication units reserved previously at time t₅. No new quota of communication units KE can now be allocated to the access network server ACS1, because the subscriber's available charge credit VG now amounts to zero. With a known charge management server 6 this can lead to an error message, since there is no longer any available charge credit present, and the connection to the first access network 4A would be terminated. With the method or the charge management server 6, however, a further recall message (quota_recall) is sent to the ACS2 server at time t₈. At time t₃ the server received a quota of 5 MB of communication units which have not yet been completely used up. In the example chosen, the server ACS2 sends a charge accounting message to the charge management server 6, the charge accounting message containing charges for the resources actually used in the amount of 1 MB. The subscriber's actual charge credit TG is accordingly reduced from 5 to 4 and the unused charges are credited to the available credit VG. Owing to the low charge level a relatively small quota of 1 MB corresponding to one charge unit is now made available to the server ACS2, as a result of which the available credit is reduced by 1. A quota of three minutes corresponding to three charge units is then made available to the server ACS1, as a result of which the available credit VG drops to zero. Thus, it is possible in the example shown to maintain the communication connection to both access networks 4A, 4B or, as the case may be, to both servers ACS1, ACS2.

The process is continued until such time as the actual credit TG has been completely used up, i.e. amounts to zero.

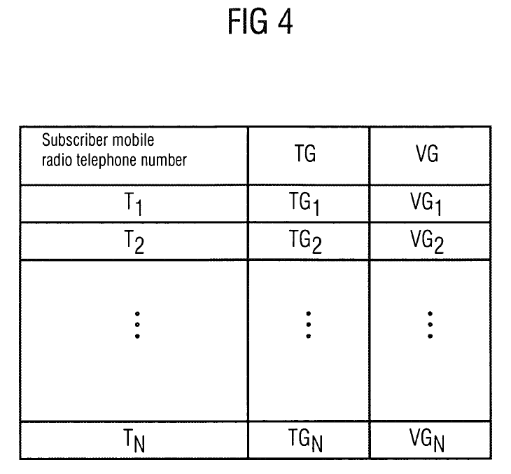

FIG. 4 shows an example of a subscriber charges table managed by the charge management server 6. A tuple having two values, namely an actual charge credit TG and a currently available charge credit VG, is managed for each mobile radio subscriber or for each subscriber mobile radio number Tᵢ.

With the method, the different messages are transmitted in accordance with a predetermined data transmission protocol, in accordance with the Diameter protocol for example. With this protocol, the charge management server 6 can actively send out messages on its own initiative. The method is suitable for managing charges in all communication systems in which charges for a plurality of communication links connected in parallel are incurred and updated simultaneously. This is the case in particular with multi-access mobile radio systems or in cases in which the network access and the application or communication services are billed separately in terms of charges.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v DIRECTV, 358 F3d 870, 69 USPQ2d 1865 (Fed. Cir. 2004).

1-14. (canceled)

15. A method for allocating communication units to access network servers of different access networks by a charge management server which manages a charge credit for each subscriber, the charge credit having an actual charge credit and an available charge credit, said method comprising:
sending from the charge management server to one of the access network servers, upon receiving a charge accounting message for accounting charges for a communication service desired by a subscriber, a recall message to recall already allocated communication units if the available charge credit of a subscriber is less than and the actual charge credit of the subscriber is greater than the charge amount specified for the desired communication service in the charge accounting message.

16. The method as claimed in claim 15, further comprising:
making a specific quota of usable communication units available to the subscriber by the charge management server, after receiving a service registration message for registering the subscriber for a desired communication service, in an allocation message; and
reducing the available charge credit of the subscriber by charges that accrue for the communication units made available.

17. The method as claimed in claim 16, wherein the charge management server sends the allocation messages and the recall messages in each case to one or more access network servers of different access networks.

18. The method as claimed in claim 17, wherein the access networks are in each case formed by a mobile radio network.

19. The method as claimed in claim 18, wherein the mobile radio network is in each case formed by at least one of a 3GPP network, a WLAN network and a WiMax network.

20. The method as claimed in claim 15, further comprising reducing, by the charge management server, after receiving another charge accounting message for accounting charges for a communication service provided for a subscriber, the actual charge credit of the subscriber by those charges that accrue for the communication units used during the provisioning of the communication service.

21. The method as claimed in claim 20, further comprising increasing, the charge management server, after receiving the other charge accounting message for accounting charges for a communication service provided for a subscriber, the available charge credit of the subscriber by those charges that accrue for a difference between the communication units made available for the communication service and the communication units used during the provisioning of the communication service.

22. The method as claimed in claim 15, further comprising:
making a new quota of usable communication units available to the subscriber by the charge management server using an allocation message, after receiving another charge accounting message for accounting charges for a communication service provided for a subscriber; and
reducing the subscriber's available charge credit by those charges that accrue for the communication units that have been made available.

23. The method as claimed in claim 15, wherein the charge management server sends an allocation message for allocating a specific quota of usable communication units to the access network server from which the charge management server has received a service registration message.

24. The method as claimed in claim 15, wherein the charge management server receives the service registration messages and the charge accounting messages in each case from one or more access network servers of different access networks.

25. The method as claimed in claim 15, wherein the communication units are formed by data volume units which specify an amount of transferable data.

26. The method as claimed in claim 15, wherein the communication units are formed by time units which specify a duration of a communication connection.

27. The method as claimed in claim 15, wherein the actual charge credit and the available charge credit of the subscriber are initialized to a starting value following payment of a charge amount by the subscriber.

28. A charge management server communicating with access servers and managing subscriber charge credits which each have an actual charge credit and an available charge credit, comprising:
a receiver receiving a charge accounting message from one of the access servers for accounting charges for a communication service desired by a subscriber; and
a transmitter sending a recall message to recall communication units already allocated for a different communication service if the available charge credit of the subscriber is less than and the actual charge credit of the subscriber is greater than a charge amount specified for the desired communication service in the charge accounting message.
